(19) United States
(12) Patent Application Publication
(10) Pub. No.: US 2024/0022089 A1
(43) Pub. Date: Jan. 18, 2024

(54) STORAGE BATTERY CONTROL DEVICE, POWER STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 18/338,249

(22) Filed: Jun. 20, 2023

(30) Foreign Application Priority Data
Jul. 12, 2022 (JP) 2022-111646

(51) Int. Cl. H02J 7/00

(52) U.S. Cl. CPC H02J 7/0016; H02J 7/00712; H02J 7/0048

(57) ABSTRACT

A storage battery control device controls a storage battery string including storage batteries connected in series and a bypass circuit configured to switch the storage batteries between a bypass state and a connection state. While causing the bypass circuit to switch the storage batteries between the bypass state and the connection state, a process of charging or discharging the storage batteries is executed to decrease a difference between remaining capacities of the storage batteries until completion of the process. And then, the process is executed while causing the bypass circuit to maintain the storage batteries in the connection state, and when the process is switched from charge to discharge or from discharge to charge, a period where a bypass prevention process of preventing the bypass circuit from switching the storage batteries from the connection state to the bypass state is executed is provided.

### CROSS-REFERENCE TO RELATED APPLICATION(S)

This application is based upon and claims the benefit of priority from prior Japanese patent application No. 2022-111646 filed on Jul. 12, 2022, the entire contents of which are incorporated herein by reference.

### BACKGROUND

### 1. Field of the Invention

The present disclosure relates to a storage battery control device, a power storage system, and a storage battery control method.

### 2. Description of the Related Art

There is known a power storage system including: a plurality of storage batteries connected in series; and a plurality of switching units each of which is provided for the corresponding storage battery and switches the corresponding storage battery between a connection state and a bypass state (for example, refer to JP2022-1006A). In the power storage system described in JP2022-1006A, in a discharge process, a first discharge control of sequentially switching the storage batteries where the remaining discharge capacity reaches a predetermined value to the bypass state is executed, and subsequently a second discharge control is executed. In the second discharge control, after the remaining discharge capacities of all of the storage batteries reach the predetermined value, all of the storage batteries are switched to the connection state, and subsequently the storage batteries that reach a discharge end state is sequentially switched to the bypass state.

In the power storage system described in JP2022-1006A, a charge control can be executed as in the discharge control. That is, in a charge process of the power storage system described in JP2022-1006A, a first charge control of making the remaining charge capacities of the plurality of storage batteries uniform is executed, and subsequently a second charge control of using up the remaining charge capacities of all of the storage batteries can be executed.

In the power storage system, a configuration in which the first charge control starts in response to a charge instruction from a higher-ranking controller during the execution of the second discharge control or a configuration in which the first discharge control starts in response to a discharge instruction from a higher-ranking controller during the execution of the second charge control can be considered. When the first charge control of making the remaining charge capacities of the plurality of storage batteries uniform starts during the execution of the second discharge control, the state where the remaining discharge capacities of the plurality of storage batteries are made uniform is collapsed. When the battery is further switched to discharge here, the control transitions from the first discharge control to the second discharge control while a sufficient period of time for making the remaining discharge capacities of the plurality of storage batteries uniform cannot be ensured, and the remaining discharge capacities of all of the storage batteries cannot be used up. On the other hand, when the first discharge control of making the remaining discharge capacities of the plurality of storage batteries uniform starts during the execution of the second charge control, the state where the remaining charge capacities of the plurality of storage batteries are made uniform is collapsed. When the battery is further switched to charge here, the control transitions from the first charge control to the second charge control while a sufficient period of time for making the remaining charge capacities of the plurality of storage batteries uniform cannot be ensured, and the remaining charge capacities of all of the storage batteries cannot be used up.

### SUMMARY

The present disclosure has been made in consideration of the above-described circumstances, and an object thereof is to provide a storage battery control device, a power storage system, and a storage battery control method, in which, in a storage battery string where a plurality of storage batteries are connected in series and each of the storage batteries is switched between a connection state and a bypass state, even when the storage batteries are frequently switched between charge and discharge, a usable capacity of the plurality of storage batteries can be increased.

According to an aspect of the present disclosure, there is provided a storage battery control device that controls a storage battery string including a plurality of storage batteries connected in series and a bypass circuit configured to switch the plurality of storage batteries between a bypass state and a connection state, in which: in a process of charging or discharging the plurality of storage batteries, a first process and a second process are executed; in the first process, while causing the bypass circuit to switch the plurality of storage batteries between the bypass state and the connection state, the process is executed to decrease a difference between remaining capacities of the plurality of storage batteries until completion of the process; in the second process, the process is executed while causing the bypass circuit to maintain the plurality of storage batteries in the connection state after the execution of the first process; and during the execution of the second process, when the process is switched from charge to discharge or from discharge to charge, a period where a bypass prevention process of preventing the bypass circuit from switching the plurality of storage batteries from the connection state to the bypass state is executed is provided.

According to another aspect of the present disclosure, there is provided a power storage system including: a storage battery string including a plurality of storage batteries connected in series and a bypass circuit configured to switch the plurality of storage batteries between a bypass state and a connection state; and a storage battery control device configured to control the storage battery string, in which: the storage battery control device executes a first process and a second process in a process of charging or discharging the plurality of storage batteries; in the first process, while causing the bypass circuit to switch the plurality of storage batteries between the bypass state and the connection state, the process is executed to decrease a difference between remaining capacities of the plurality of storage batteries until completion of the process; in the second process, the process is executed while causing the bypass circuit to maintain the plurality of storage batteries in the connection state after the execution of the first process; and during the execution of the second process, when the process is switched from charge to discharge or from discharge to charge, a period where a bypass prevention process of preventing the bypass circuit from switching the plurality of storage batteries from the connection state to the bypass state is executed is provided.

According to still another aspect of the present disclosure, there is provided a storage battery control method that is executed by a storage battery control device that controls a storage battery string including a plurality of storage batteries connected in series and a bypass circuit configured to switch the plurality of storage batteries between a bypass state and a connection state, in which: in a process of charging or discharging the plurality of storage batteries, a first procedure and a second procedure are executed; in the first procedure, while causing the bypass circuit to switch the plurality of storage batteries between the bypass state and the connection state, the process is executed to decrease a difference between remaining capacities of the plurality of storage batteries until completion of the process; in the second procedure, the process is executed while causing the bypass circuit to maintain the plurality of storage batteries in the connection state after the execution of the first procedure; and during the execution of the second procedure, when the process is switched from charge to discharge or from discharge to charge, a period where a bypass prevention procedure of preventing the bypass circuit from switching the plurality of storage batteries from the connection state to the bypass state is executed is provided.

According to the present disclosure, in a storage battery string where a plurality of storage batteries are connected in series and each of the storage batteries is switched between a connection state and a bypass state, even when the storage batteries are frequently switched between charge and discharge, a usable capacity of the plurality of storage batteries can be increased.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a circuit diagram showing a summary of a power storage system including a storage battery control device according to one embodiment of the present disclosure;

FIG. 2 is a timing chart showing a charge control according to the embodiment of the present disclosure;

FIG. 3 is a table showing the charge control according to the embodiment of the present disclosure shown in the timing chart of FIG. 2;

FIG. 4 is a timing chart showing a discharge control according to the embodiment of the present disclosure;

FIG. 5 is a table showing the discharge control according to the embodiment of the present disclosure shown in the timing chart of FIG. 4;

FIG. 6 is a timing chart showing a relationship between an SOC of a storage battery string and a bypass prevention discharge process, a first discharge process, a second discharge process, a bypass prevention charge process, a first charge process, and a second charge process;

FIG. 7 is a timing chart showing a relationship between the SOC of the storage battery string and the bypass prevention discharge process, the first discharge process, the second discharge process, the bypass prevention charge process, the first charge process, and the second charge process; and

FIG. 8 is a timing chart showing a relationship between the SOC of the storage battery string and the bypass prevention discharge process, the first discharge process, the second discharge process, the bypass prevention charge process, the first charge process, and the second charge process.

### DETAILED DESCRIPTION OF THE INVENTION

Hereinafter, the present disclosure will be described using a preferable embodiment. The present disclosure is not limited to the following embodiment, and the embodiment can be appropriately changed within a range not departing from the scope of the present disclosure. In the following embodiment, some components are not shown or are not described. Regarding the details of the techniques that are not described, well-known or commonly known techniques can be applied within a range not causing inconsistency with the contents of the following description.

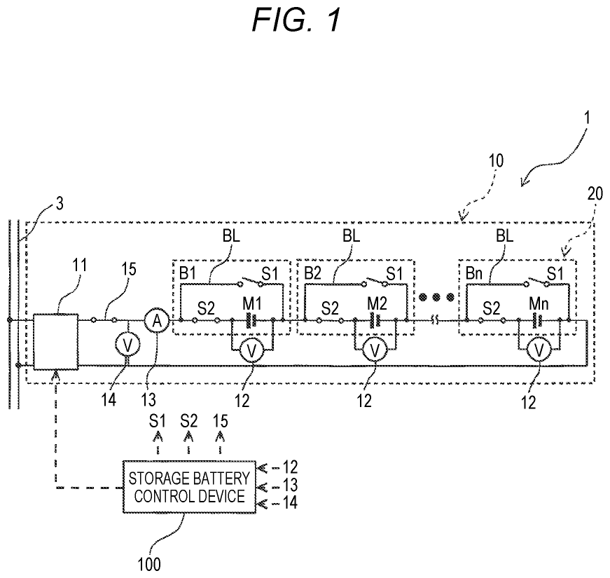

FIG. 1 is a circuit diagram showing the summary of a power storage system 1 including a storage battery control device 100 according to one embodiment of the present disclosure. As shown in the drawing, the power storage system 1 includes a storage battery string 10 and the storage battery control device 100.

The storage battery string 10 is an in-vehicle or stationary power supply including n (n represents an integer of 2 or more) storage battery modules M1 to Mn connected in series. Although not particularly limited, the storage battery modules M1 to Mn according to the embodiment are obtained by regenerating used batteries, and there is a difference between the degrees of deterioration of the storage battery modules M1 to Mn. In the storage battery modules M1 to Mn, a plurality of secondary battery cells such as lithium ion batteries or lithium ion capacitors are connected to each other. The storage battery modules M1 to Mn are charged with electrical power supplied from an external system (not shown) through a string bus 3 and a power converter 11 described below, and supply (discharge) the power to the external system through the power converter 11 and the string bus 3. Instead of including the n storage battery modules M1 to Mn connected in series, the storage battery string 10 may include a plurality of storage battery cells or storage battery packs connected in series and may further include a bypass circuit that bypasses each of the storage battery cells or each of the storage battery packs.

The storage battery string 10 includes the power converter 11, n voltage sensors 12, one current sensor 13, one voltage sensor 14, and one string disconnect switch 15. The power converter 11 is a DC/DC converter or a DC/AC converter and is connected to the string bus 3. A positive electrode of the storage battery module M1 at a starting end and a negative electrode of the storage battery module Mn at a terminal end are connected to the power converter 11.

The power converter 11 converts voltages input from the string bus 3 during the charge of the storage battery string 10 into values corresponding to charge power values or charge current values set by a higher-ranking controller (not shown) and outputs the converted values to the plurality of storage battery modules M1 to Mn. Here, the voltages of the storage battery string 10 change depending on bypass states of the storage battery modules M1 to Mn (the number of the bypassed storage battery modules M1 to Mn) or states of charge of the storage battery modules M1 to Mn. Therefore, the power converter 11 converts a voltage input from the string bus 3 during the charge of the storage battery string 10 into the voltage of the storage battery string 10 and outputs the converted values to the plurality of storage battery modules M1 to Mn.

The power converter 11 converts voltages input from the plurality of storage battery modules M1 to Mn during the discharge of the storage battery string 10 into values corresponding to discharge power values or discharge current values set by the higher-ranking controller and outputs the converted values to the string bus 3. Here, the input voltages of the power converter 11 during discharge change depending on the bypass states of the storage battery modules M1 to Mn and the states of charge of the storage battery modules M1 to Mn. Therefore, when the plurality of storage battery strings 10 are connected in parallel, there is a variation in the input voltage of the power converter 11 between the storage battery strings 10 during discharge. Here, during the discharge of the storage battery string 10, the power converter 11 converts the input voltage into a voltage consistent with another storage battery string 10 and outputs the converted value into the string bus 3.

When the current flowing through the string bus 3 is a direct current, the power converter 11 is a DC/DC converter. When the current flowing through the string bus 3 is an alternating current, the power converter 11 is a DC/AC converter. When the current flowing through the string bus 3 is an alternating current, the power converter 11 includes a synchronization unit for following a change in instantaneous value.

The voltage sensor 12 is connected between positive and negative electrode terminals of each of the storage battery modules M1 to Mn, and transmits a detection signal of a voltage between the terminals of each of the storage battery modules M1 to Mn to the storage battery control device 100. The current sensor 13 is provided in a current path of the storage battery string 10, and detects a charge/discharge current of the storage battery string 10 and transmits the detection signal to the storage battery control device 100. The voltage sensor 14 is provided in the current path of the storage battery string 10, and detects a total voltage of the storage battery string 10 and transmits the detection signal to the storage battery control device 100.

The string disconnect switch 15 is provided between the power converter 11 and the storage battery module M1 at the starting end. The string disconnect switch 15 connects or disconnects the storage battery string 10 to or from the string bus 3. The string disconnect switch 15 may be provided between the string bus 3 and the power converter 11.

A bypass circuit 20 includes n (n represents an integer of 2 or more) bypass units B1 to Bn that are provided in the storage battery modules M1 to Mn, respectively. Each of the bypass units B1 to Bn includes a bypass line BL and switches S1 and S2. The bypass line BL is a power line that bypasses each of the storage battery modules M1 to Mn. The switch S1 is provided in the bypass line BL. The switch S1 is, for example, a mechanical switch, a semiconductor switch, or a relay. The switch S2 is provided between the positive electrode of each of the storage battery modules M1 to Mn and one end of the bypass line BL. The switch S2 is, for example, a semiconductor switch or a relay.

The storage battery module M1 at the starting end and the storage battery module Mn at the terminal end are connected to the external system through the power converter 11 and the string bus 3. When the switch S1 is OFF and the switch S2 is ON in all of the bypass units B1 to Bn, all of the storage battery modules M1 to Mn are connected in series to the external system. On the other hand, when the switch S2 is OFF and the switch S1 is ON in any of the bypass units B1 to Bn, the storage battery modules M1 to Mn corresponding to the bypass units B1 to Bn are bypassed.

The storage battery control device 100 is connected to the power converter 11, the voltage sensors 12, the current sensor 13, the voltage sensor 14, the string disconnect switch 15, and the switches S1 and S2 of the bypass units B1 to Bn. The storage battery control device 100 executes a charge/discharge control by the power converter 11, monitoring of each of the storage battery modules M1 to Mn, and a switching control of the switches S1 and S2 of each of the bypass units B1 to Bn.

The storage battery control device 100 according to the embodiment switches the switches S1 and S2 of each of the bypass units B1 to Bn based on a remaining charge capacity RC until charge completion of each of the storage battery modules M1 to Mn, and controls the charge of the storage battery string 10 by the power converter 11. In the following description, the remaining charge capacity RC until charge completion of each of the storage battery modules M1 to Mn will be simply referred to as the remaining charge capacity RC. The remaining charge capacity RC is the capacity with which each of the storage battery modules M1 to Mn can be charged during the charge until the voltage reaches a charge end voltage.

During the execution of the charge process, the storage battery control device 100 calculates the remaining charge capacity RC of each of the storage battery modules M1 to Mn based on measured values of the voltage sensors 12 and the current sensor 13. In the embodiment, the storage battery control device 100 calculates the remaining charge capacity RC [Ah] of each of the storage battery modules M1 to Mn from the following Expression (1).

RC[Ah]=CC×(100−SOC)/100 (1)

Note that CC represents the current battery capacity of each of the storage battery modules M1 to Mn (in the embodiment, the current capacity [Ah]) can be calculated from the following Expression (2). SOC represents the state of charge [%] of each of the storage battery modules M1 to Mn and can be estimated using various well-known methods such as a current integration method, a method of acquiring the SOC from an open circuit voltage (voltage method), or a combination method of the current integration method and the voltage method.

CC[Ah]=C₀×SOH/100 (2)

Note that C₀ represents the current capacity (Ah) when each of the storage battery modules M1 to Mn is new. SOH represents the state of health (SOH) of each of the storage battery modules M1 to Mn and is estimated based on the measured values of the voltage sensors 12 and the current sensor 13.

As a method of calculating the SOH of each of the storage battery modules M1 to Mn, various well-known methods of estimating the SOH using a change over time in SOC and/or an increase over time in internal resistance may be used. Examples of the method of estimating the SOH include: a method using a charge/discharge test, a method using the current integration method, a method using measurement of an open circuit voltage, a method using measurement of a terminal voltage, and a method based on a model (all of which are methods using a change over time in SOC); and a method using alternating current impedance measurement, a method of acquiring the SOH using an adaptive digital filter based on a model, a method using linear regression from I-V characteristics (a slope of a straight line of I-V characteristics) from I-V characteristics (current-voltage characteristics), and a method using a step response (all of which are estimation methods using an increase over time in internal resistance).

The storage battery control device 100 controls the switching between ON and OFF of the switches S1 and S2 of each of the bypass units B1 to Bn based on the calculated remaining charge capacity RC of each of the storage battery modules M1 to Mn. The storage battery control device 100 controls the charge of the storage battery modules M1 to Mn in the connection state by the power converter 11 based on the calculated remaining charge capacity RC of each of the storage battery modules M1 to Mn.

Specifically, the storage battery control device 100 preferentially bypasses one of the storage battery modules M1 to Mn having a lower remaining charge capacity RC than the other ones of the storage battery modules M1 to Mn using each of the bypass units B1 to Bn. The storage battery control device 100 charges the storage battery modules M1 to Mn in the connection state such that a difference between the remaining charge capacities RC of the plurality of storage battery modules M1 to Mn decreases (first charge process). That is, the storage battery control device 100 controls the amount of charge to the storage battery modules M1 to Mn such that the remaining charge capacities RC of all of the storage battery modules M1 to Mn are made uniform during the execution of the first charge process. The storage battery control device 100 switches all of the storage battery modules M1 to Mn where the remaining charge capacities RC are made uniform to the connection state using the bypass units B1 to Bn after the execution of the first charge process, and charges all of the storage battery modules M1 to Mn in the connection state (second charge process).

The storage battery control device 100 switches the switch S2 to OFF and switches the switch S1 to ON in the bypass units B1 to Bn corresponding to the storage battery modules M1 to Mn in the bypass state. The storage battery control device 100 switches the switch S1 to OFF and switches the switch S2 to ON in the bypass units B1 to Bn corresponding to the storage battery modules M1 to Mn in the connection state.

The storage battery control device 100 estimates the SOC of the storage battery string 10 based on the measured values of the voltage sensors 12 and 14 and the current sensor 13. The SOC of the storage battery string 10 can be estimated using various well-known methods such as a current integration method, a method of acquiring the SOC from an open circuit voltage (voltage method), or a combination method of the current integration method and the voltage method.

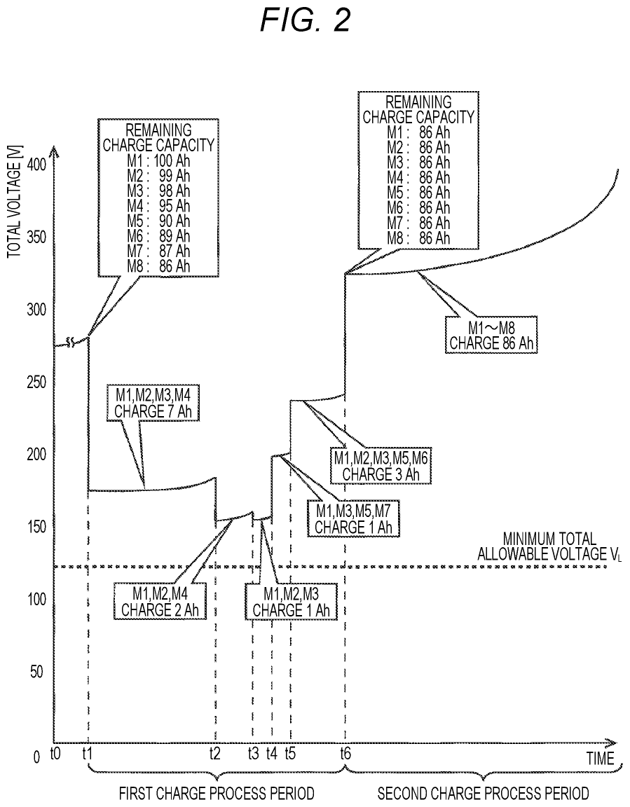

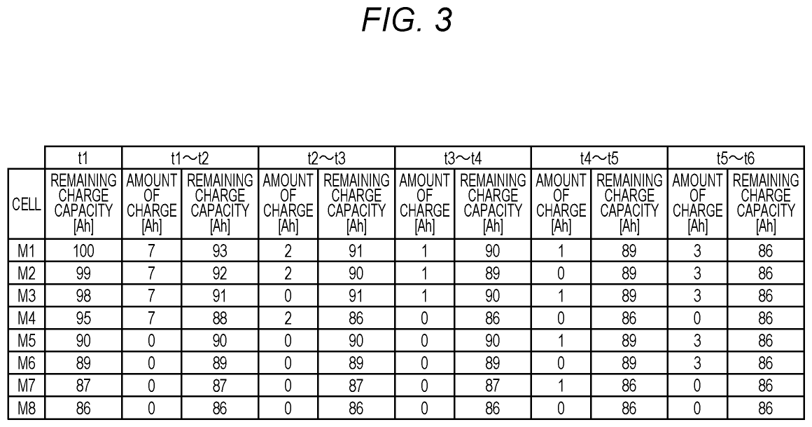

FIG. 2 is a timing chart showing the charge control according to the embodiment. FIG. 3 is a table showing the charge control according to the embodiment shown in the timing chart of FIG. 2. As shown in the drawings, in the charge control according to the embodiment, the charge of eight storage battery modules M1 to M8 is controlled. The drawings show the example of the charge control during the execution of the first charge process and the second charge process.

As shown in FIGS. 2 and 3, the remaining charge capacities RC of the eight storage battery modules M1 to M8 at the start of the first charge process are 100 [Ah], 99 [Ah], 98 [Ah], 95 [Ah], 90 [Ah], 89 [Ah], 87 [Ah], and 86 [Ah], respectively. In the charge control according to the embodiment, the storage battery control device 100 (refer to FIG. 1) executes a bypass prevention charge process before executing the first charge process. In the bypass prevention charge process, the bypass of all of the storage battery modules M1 to M8 is prevented, and all of the storage battery modules M1 to M8 in the connection state are charged. The bypass prevention charge process will be described below.

In the first charge process, the storage battery control device 100 preferentially bypasses one of the storage battery modules M1 to M8 having a lower remaining charge capacity RC than the other ones of the storage battery modules M1 to M8. That is, in the first charge process, the storage battery control device 100 charges the storage battery modules M1 to Mn in the connection state such that a difference between the remaining charge capacities RC of the plurality of storage battery modules M1 to Mn decreases.

In the first charge process, the storage battery control device 100 bypasses the storage battery module (in the example shown in the drawing, M8) having the minimum remaining charge capacity RC at the start of the first charge process continuously from start to end of the first charge process, and bypasses or connects the other storage battery modules (in the example shown in the drawing, M1 to M7). As a result, the remaining charge capacities RC of all of the storage battery modules M1 to M8 are made uniform to the minimum value (in the example shown in the drawing, 86 Ah) of the remaining charge capacity RC at the start of the first charge process. In the first charge process, the storage battery control device 100 connects the storage battery module (in the example shown in the drawing, M1) having the maximum remaining charge capacity RC at the start of the first charge process continuously from start to end of the process without being bypassed, and connects or bypasses the other storage battery modules (in the example shown in the drawing, M2 to M7) such that, as the remaining charge capacity RC decreases, the number of times the storage battery module is bypassed increases. As a result, a difference between the remaining charge capacities RC gradually decreases. The first charge process is exemplary and may be appropriately changed.

In the first charge process, the storage battery control device 100 selects the storage battery modules M1 to M8 to be bypassed such that a condition that the total voltage of the power storage system 1 (refer to FIG. 1) is a minimum total allowable voltage V_{L} or higher is satisfied. In the example shown in the drawing, during start to end of the first charge process, the storage battery control device 100 connect three or more of the storage battery modules M1 to M7 such that a state where the total voltage of the power storage system 1 is higher than the minimum total allowable voltage V_{L} is maintained.

In the example of the first charge process shown in FIG. 2, first, at time t1, the storage battery control device 100 bypasses not only the storage battery module M8 having the minimum remaining charge capacity RC but also the storage battery modules M5, M6, and M7 having a lower initial remaining charge capacity RC than the other storage battery modules. On the other hand, at the time t1, the storage battery control device 100 connects the storage battery modules M1, M2, M3, and M4 having a higher initial remaining charge capacity RC than the other storage battery modules.

In a period from the time t1 to time t2, the storage battery control device 100 charges the four storage battery modules M1 to M4 in the connection state. The amounts of charge to the four storage battery modules M1 to M4 are 7 [Ah]. For example, assuming that the amounts of charge to the four storage battery modules M1 to M4 are 9 [Ah], the remaining charge capacity RC of the storage battery module M4 can also be decreased until a target value of 86 [Ah].

Next, at the time t2, the storage battery control device 100 bypasses not only the storage battery modules M5 to M8 but also the storage battery module M3, and connects the other storage battery modules M1, M2, and M4. In a period from the time t2 to time t3, the storage battery control device 100 charges the three storage battery modules M1, M2, and M4 in the connection state. The amounts of charge to the three storage battery modules M1, M2, and M4 are 2 [Ah]. As a result, the remaining charge capacity RC of the storage battery module M4 decreases until the target value of 86 [Ah].

Next, at the time t3, the storage battery control device 100 bypasses not only the storage battery module M4 where the remaining charge capacity RC is decreased until the target value but also the storage battery modules M5 to M8, and connects the storage battery module M3 that has been bypassed. In a period from the time t3 to time t4, the storage battery control device 100 charges the three storage battery modules M1, M2, and M3 in the connection state. The amounts of charge to the three storage battery modules M1, M2, and M3 are 1 [Ah].

Next, at the time t4, the storage battery control device 100 bypasses not only the storage battery modules M4 and M8 where the remaining charge capacity RC is the target value but also the storage battery modules M2 and M6, and connects the storage battery modules M5 and M7 that have been bypassed. In a period from the time t4 to time t5, the storage battery control device 100 charges the four storage battery modules M1, M3, M5 and M7 in the connection state. The amounts of charge to the four storage battery modules M1, M3, M5 and M7 are 1 [Ah]. As a result, the remaining charge capacity RC of the storage battery module M7 decreases until the target value of 86 [Ah]. The remaining charge capacities RC of the storage battery modules M1, M2, M3, M5, and M6 are made uniform to 89 [Ah].

Next, at the time t5, the storage battery control device 100 bypasses not only the storage battery modules M4, M7, and M8 where the remaining charge capacity RC is the target value, and connects the storage battery modules M2 and M6 that have been bypassed. In a period from the time t5 to time t6, the storage battery control device 100 charges the five storage battery modules M1, M2, M3, M5, and M6 in the connection state. The amounts of charge to the five storage battery modules M1, M2, M3, M5, and M6 are 3 [Ah]. As a result, the remaining charge capacities RC of the storage battery modules M1, M2, M3, M5, and M6 decreases until the target value of 86 [Ah], and the remaining charge capacities RC of all of the storage battery modules M1 to M8 are made uniform to the target value of 86 [Ah].

Next, in a period from the time t6 to the charge completion, the storage battery control device 100 charges all of the storage battery modules M1 to M8 in the connection state (second charge process). The amounts of charge to all of the storage battery modules M1 to M8 in the second charge process are 86 [Ah]. Here, the second charge process is executed continuously until charge completion unless a discharge instruction is transmitted from the higher-ranking controller to the storage battery control device 100.

On the other hand, the storage battery control device 100 according to the embodiment switches the switches S1 and S2 of each of the bypass units B1 to Bn based on a remaining discharge capacity RD until discharge completion of each of the storage battery modules M1 to Mn, and controls the discharge of the storage battery string 10 by the power converter 11. In the following description, the remaining discharge capacity RD until discharge completion of each of the storage battery modules M1 to Mn will be simply referred to as the remaining discharge capacity RD. The remaining discharge capacity RD is the capacity with which each of the storage battery modules M1 to Mn can be discharged during the discharge until the voltage reaches a discharge end voltage.

During the execution of the discharge process, the storage battery control device 100 calculates the remaining discharge capacity RD of each of the storage battery modules M1 to Mn based on the measured values of the voltage sensors 12 and the current sensor 13. In the embodiment, the storage battery control device 100 calculates the remaining discharge capacity RD [Ah] of each of the storage battery modules M1 to Mn from the following Expression (3).

RD[Ah]=CC×(100−SOC)/100 (3)

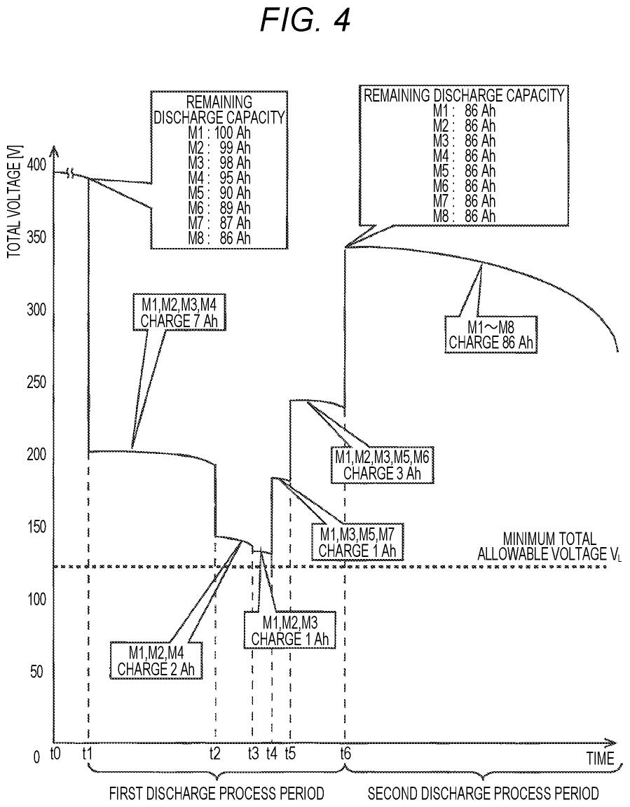

FIG. 4 is a timing chart showing the discharge control according to the embodiment.

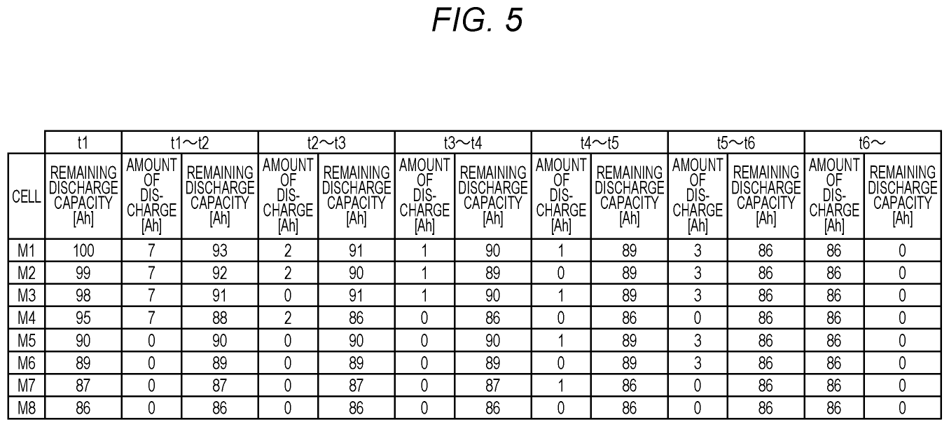

FIG. 5 is a table showing the discharge control according to the embodiment shown in the timing chart of FIG. 4. As shown in the drawings, in the discharge control according to the embodiment, the discharge of the eight storage battery modules M1 to M8 is controlled. The drawings show the example of the discharge control during the execution of the first discharge process and the second discharge process.

As shown in FIGS. 4 and 5, the remaining discharge capacities RD of the eight storage battery modules M1 to M8 at the start of the first discharge process are 100 [Ah], 99 [Ah], 98 [Ah], 95 [Ah], 90 [Ah], 89 [Ah], 87 [Ah], and 86 [Ah], respectively. In the discharge control according to the embodiment, the storage battery control device 100 (refer to FIG. 1) executes a bypass prevention discharge process before executing the first discharge process. In the bypass prevention discharge process, the bypass of all of the storage battery modules M1 to M8 is prevented, and all of the storage battery modules M1 to M8 in the connection state are discharged. The bypass prevention discharge process will be described below.

In the first discharge process, the storage battery control device 100 preferentially bypasses one of the storage battery modules M1 to M8 having a lower remaining discharge capacity RD than the other ones of the storage battery modules M1 to M8. That is, in the first discharge process, the storage battery control device 100 discharges the storage battery modules M1 to Mn such that a difference between the remaining discharge capacities RD of the plurality of storage battery modules M1 to Mn decreases.

In the first discharge process, the storage battery control device 100 bypasses the storage battery module (in the example shown in the drawing, M8) having the minimum remaining discharge capacity RD at the start of the first discharge process continuously from start to end of the process, and bypasses or connects the other storage battery modules (in the example shown in the drawing, M1 to M7). As a result, the remaining charge capacities RC of all of the storage battery modules M1 to M8 are made uniform to the minimum value (in the example shown in the drawing, 86 Ah) of the initial remaining discharge capacity RD. In the first discharge process, the storage battery control device 100 connects the storage battery module (in the example shown in the drawing, M1) having the maximum remaining discharge capacity RD at the start of the first discharge process continuously from start to end of the process without being bypassed, and connects or bypasses the other storage battery modules (in the example shown in the drawing, M2 to M7) such that, as the remaining discharge capacity RD decreases, the number of times the storage battery module is bypassed increases. As a result, a difference between the remaining discharge capacities RD gradually decreases. Here, the first discharge process is exemplary and may be appropriately changed.

Here, in the first discharge process, the storage battery control device 100 selects the storage battery modules M1 to M8 to be bypassed such that a condition that the total voltage of the power storage system 1 (refer to FIG. 1) is a minimum total allowable voltage V_{L} or higher is satisfied. In the example shown in the drawing, during start to end of the first discharge process, the storage battery control device 100 connects three or more of the storage battery modules M1 to M7 such that a state where the total voltage of the power storage system 1 is higher than the minimum total allowable voltage V_{L} is maintained.

In the example of the first discharge process shown in FIG. 4, first, at the time t1, the storage battery control device 100 bypasses not only the storage battery module M8 having the minimum remaining discharge capacity RD but also the storage battery modules M5, M6, and M7 having a lower initial remaining discharge capacity RD than the other storage battery modules. On the other hand, at the time t1, the storage battery control device 100 connects the storage battery modules M1, M2, M3, and M4 having a higher initial remaining discharge capacity RD than the other storage battery modules.

In a period from the time t1 to time t2, the storage battery control device 100 discharges the four storage battery modules M1 to M4 in the connection state. The amounts of discharge from the four storage battery modules M1 to M4 are 7 [Ah]. For example, assuming that the amounts of discharge from the four storage battery modules M1 to M4 are 9 [Ah], the remaining discharge capacity RD of the storage battery module M4 can also be decreased until a target value of 86 [Ah].

Next, at the time t2, the storage battery control device 100 bypasses not only the storage battery modules M5 to M8 but also the storage battery module M3, and connects the other storage battery modules M1, M2, and M4. In a period from the time t3 to time t4, the storage battery control device 100 discharges the three storage battery modules M1, M2, and M3 in the connection state. The amounts of discharge from the three storage battery modules M1, M2, and M4 are 2 [Ah]. As a result, the remaining discharge capacity RD of the storage battery module M4 decreases until the target value of 86 [Ah].

Next, at the time t3, the storage battery control device 100 bypasses not only the storage battery module M4 where the remaining discharge capacity RD is decreased until the target value but also the storage battery modules M5 to M8, and connects the storage battery module M3 that has been bypassed. In a period from the time t3 to time t4, the storage battery control device 100 discharges the three storage battery modules M1, M2, and M3 in the connection state. The amounts of discharge from the three storage battery modules M1, M2, and M3 are 1 [Ah].

Next, at the time t4, the storage battery control device 100 bypasses not only the storage battery modules M4 and M8 where the remaining discharge capacity RD is decreased until the target value but also the storage battery modules M2 to M6, and connects the storage battery modules M5 and M7 that have been bypassed. In a period from the time t4 to time t5, the storage battery control device 100 discharges the four storage battery modules M1, M3, M5 and M7 in the connection state. The amounts of discharge from the four storage battery modules M1, M3, M5 and M7 are 1 [Ah]. As a result, the remaining discharge capacity RD of the storage battery module M7 decreases until the target value of 86 [Ah]. The remaining discharge capacities RD of the storage battery modules M1, M2, M3, M5, and M6 are made uniform to 89 [Ah].

Next, at the time t5, the storage battery control device 100 bypasses the storage battery modules M4, M7, and M8 where the remaining discharge capacity RD is decreased until the target value, and connects the storage battery modules M2 and M6 that have been bypassed. In a period from the time t5 to time t6, the storage battery control device 100 discharges the five storage battery modules M1, M2, M3, M5, and M6 in the connection state. The amounts of discharge from the five storage battery modules M1, M2, M3, M5, and M6 are 3 [Ah]. As a result, the remaining discharge capacities RD of the storage battery modules M1, M2, M3, M5, and M6 decreases until the target value of 86 [Ah], and the remaining discharge capacities RD of all of the storage battery modules M1 to M8 are made uniform to the target value of 86 [Ah].

Next, at time t6, the storage battery control device 100 connects all of the storage battery modules M1 to M8. Next, in a period from the time t6 to discharge completion, the storage battery control device 100 discharges all of the storage battery modules M1 to M8 in the connection state (second discharge process). The amounts of discharge from all of the storage battery modules M1 to M8 in the second discharge process are 86 [Ah]. Here, the second discharge process is executed continuously until the discharge completion unless a charge instruction is transmitted from the higher-ranking controller to the storage battery control device 100.

Here, when a charge instruction is transmitted from the higher-ranking controller to the storage battery control device 100 during the execution of the second discharge process, the storage battery control device 100 executes the above-described bypass prevention charge process. On the other hand, when a discharge instruction is transmitted from the higher-ranking controller to the storage battery control device 100 during the execution of the second charge process, the storage battery control device 100 executes the above-described bypass prevention discharge process. Hereinafter, this point will be described.

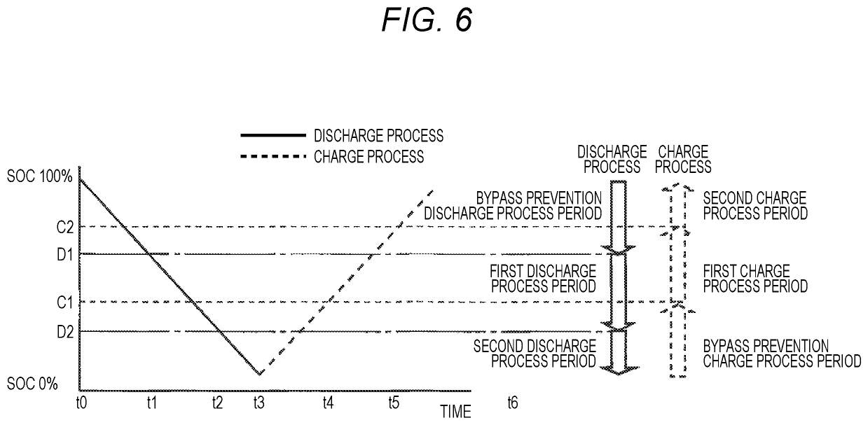

FIGS. 6 to 8 are timing charts showing a relationship between the SOC of the storage battery string 10 (hereinafter, referred to as the string SOC) and the bypass prevention discharge process, the first discharge process, the second discharge process, the bypass prevention charge process, the first charge process, and the second charge process. As shown in the timing charts, the storage battery control device 100 (refer to FIG. 1) selects the bypass prevention discharge process, the first discharge process, and the second discharge process depending on the string SOC [%] during the execution of the discharge process. On the other hand, the storage battery control device 100 selects the bypass prevention charge process, the first charge process, and the second charge process depending on the string SOC [%] during the execution of the charge process.

When the string SOC [%] satisfies D1<the string SOC [%]<100 during the execution of the discharge process, the storage battery control device 100 executes the bypass prevention discharge process. That is, when the storage battery control device 100 starts discharge from a state of charge where the string SOC [%] is D1 or higher, the storage battery control device 100 maintains a state where all of the storage battery modules M1 to Mn are connected while the string SOC [%] decreases to D1 from the start of discharge (in the period from the time t0 to the time t1 of FIG. 6). D1 that is the string SOC [%] when the bypass prevention discharge process ends will be referred to as the lower limit threshold D1 of the bypass prevention discharge process.

When the string SOC [%] satisfies D2<the string SOC [%]<D1 during the execution of the discharge process, the storage battery control device 100 executes the first discharge process. That is, the storage battery control device 100 executes the switching control of the switches S1 and S2 of each of the bypass units B1 to Bn such that a difference between the remaining discharge capacities RD of the storage battery modules M1 to Mn decreases while the string SOC [%] decreases from the lower limit threshold D1 of the bypass prevention discharge process to D2 by discharge (in the period from the time t1 to the time t2 of FIG. 6). D2 that is the string SOC [%] when the first discharge process ends will be referred to as the lower limit threshold D2 of the first discharge process.

When the string SOC [%] satisfies 0<the string SOC [%]<D2 during the execution of the discharge process, the storage battery control device 100 executes the second discharge process. That is, the storage battery control device 100 maintains the state where all of the storage battery modules M1 to Mn are connected while the string SOC [%] decreases from the lower limit threshold D2 of the first discharge process by discharge (in the period from the time t2 to the time t3 of FIG. 6).

On the other hand, when the string SOC [%] satisfies 0≤the string SOC [%]≤C1 during the execution of the charge process, the storage battery control device 100 executes the bypass prevention charge process. That is, when the storage battery control device 100 starts charge from a state of charge where the string SOC [%] is C1 or lower, the storage battery control device 100 maintains a state where all of the storage battery modules M1 to Mn are connected while the string SOC [%] increases to C1 from the start of charge (in the period from the time t3 to the time t4 of FIG. 6). C1 that is the string SOC [%] when the bypass prevention charge process ends will be referred to as the upper limit threshold C1 of the bypass prevention charge process.

When the string SOC [%] satisfies C1<the string SOC [%]<C2 during the execution of the charge process, the storage battery control device 100 executes the first charge process. That is, the storage battery control device 100 executes the switching control of the switches S1 and S2 of each of the bypass units B1 to Bn such that a difference between the remaining charge capacities RC of the storage battery modules M1 to Mn decreases while the string SOC [%] increases from the upper limit threshold C1 of the bypass prevention charge process to C2 by charge (in the period from the time t4 to the time t5 of FIG. 6). C2 that is the string SOC [%] when the first charge process ends will be referred to as the upper limit threshold C2 of the first charge process.

When the string SOC [%] satisfies C2≤the string SOC [%]≤100 during the execution of the charge process, the storage battery control device 100 executes the second charge process. That is, the storage battery control device 100 maintains the state where all of the storage battery modules M1 to Mn are connected while the string SOC [%] increases from the upper limit threshold C2 of the first charge process by charge (after the time t5 of FIG. 6).

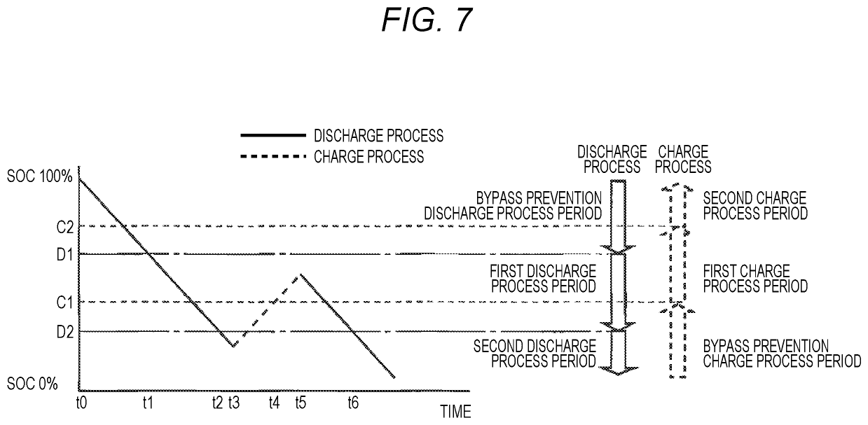

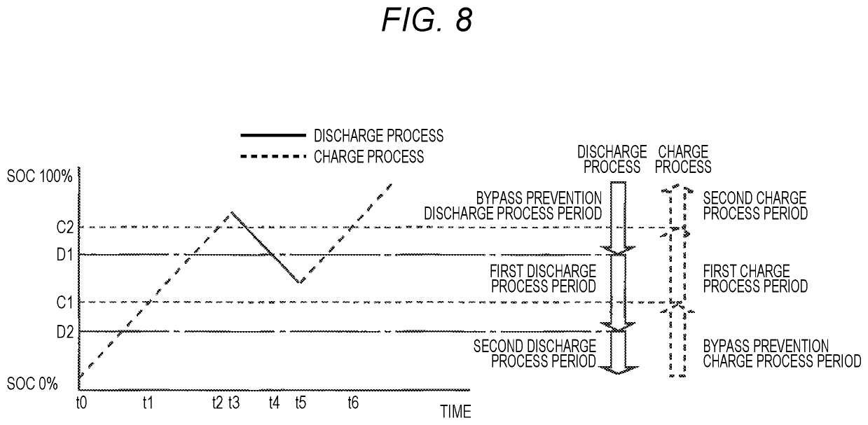

Here, FIG. 6 shows the example where the process is switched from the discharge process to the charge process after executing the discharge process in the period from the state where the string SOC [%] is full charge of 100% to the state where the string SOC [%] is close to full discharge of 0%. FIG. 6 shows the example where the charge process is executed in the period from the state where the string SOC [%] is full discharge of 0% to the state where the string SOC [%] is full charge of 100%. On the other hand, when a charge instruction is transmitted from the higher-ranking controller to the storage battery control device 100 during the execution of the second discharge process, the process is instantaneously switched from the second discharge process to the charge process as shown in FIG. 7. When a discharge instruction is transmitted from the higher-ranking controller to the storage battery control device 100 during the execution of the second charge process, the process is instantaneously switched from the second charge process to the discharge process as shown in FIG. 8.

Here, when the process is switched to the first charge process during the execution of the second discharge process, the state where the remaining discharge capacities RD of the storage battery modules M1 to Mn are made uniform in the first discharge process is collapsed by the bypassing of the storage battery modules M1 to Mn in the first charge process. Here, when the process is further switched from the charge process to the discharge process, the discharge process progresses while a period of the first discharge process where the remaining discharge capacities RD of the storage battery modules M1 to Mn are made uniform cannot be ensured. As a result, the discharge process is completed while the remaining discharge capacities RD of the storage battery modules M1 to Mn cannot be used up.

Therefore, in the embodiment, to prevent the process from being instantaneously switched to the first charge process during the execution of the second discharge process, the lower limit threshold D2 of the first discharge process and the upper limit threshold C1 of the bypass prevention charge process are set to satisfy a relationship of D2≤C1.

Likewise, when the process is switched to the first discharge process during the execution of the second charge process, the state where the remaining charge capacities RC of the storage battery modules M1 to Mn are made uniform in the first charge process is collapsed by the bypassing of the storage battery modules M1 to Mn in the first charge process. Here, when the process is further switched from the discharge process to the charge process, the charge process progresses while a period of the first charge process where the remaining charge capacities RC of the storage battery modules M1 to Mn are made uniform cannot be ensured. As a result, the charge process is completed while the remaining charge capacities RC of the storage battery modules M1 to Mn cannot be used up.

Therefore, in the embodiment, to prevent the process from being instantaneously switched to the first discharge process during the execution of the second charge process, the upper limit threshold C2 of the first charge process and the lower limit threshold D1 of the bypass prevention discharge process are set to satisfy a relationship of C2≥D1.

FIG. 7 shows the example where, after executing the discharge process in the period from the state where the string SOC [%] is full charge of 100% to the state of charge where the string SOC [%] falls below D2, the process is switched to the charge process and subsequently is further switched from the charge process to the discharge process. In the period from the time t2 to the time t3, the storage battery control device 100 executes the second discharge process and switches the process from the discharge process to the charge process in response to a charge instruction from the higher-ranking controller at the time t3. The storage battery control device 100 switches the process from the charge process to the discharge process in response to a discharge instruction from the higher-ranking controller at the time t5.

Here, at the time t3, the string SOC [%] is lower than the upper limit threshold C2 of the first charge process and is lower than the upper limit threshold C1 of the bypass prevention charge process. Therefore, the storage battery control device 100 switches the process from the second discharge process to the bypass prevention charge process in response to a charge instruction from the higher-ranking controller at the time t3. As a result, a state where all of the storage battery modules M1 to Mn are connected is maintained while the string SOC [%] increases to C1 after the switch from the second discharge process to the charge process (in the period from the time t3 to the time t4). That is, a state where the remaining discharge capacities RD of all of the storage battery modules M1 to Mn are made uniform is maintained for a certain period after the switch from the second discharge process to the charge process. Accordingly, when the process is further switched to the discharge process in the period, the first discharge process or the second discharge process can be executed while the remaining discharge capacities RD of all of the storage battery modules M1 to Mn are made uniform, and the remaining discharge capacities RD of all of the storage battery modules M1 to Mn can be used up.

FIG. 8 shows the example where, after executing the charge process in the period from the state where the string SOC [%] falls below D2 to the state of charge where the string SOC [%] exceeds C2, the process is switched to the discharge process and subsequently is further switched to the charge process. In the period from the time t2 to the time t3, the storage battery control device 100 executes the second charge process and switches the process from the charge process to the discharge process in response to a discharge instruction from the higher-ranking controller at the time t3. The storage battery control device 100 switches the process from the discharge process to the charge process in response to a charge instruction from the higher-ranking controller at the time t5.

Here, at the time t3, the string SOC [%] is higher than the upper limit threshold C2 of the first charge process and is higher than the lower limit threshold D1 of the bypass prevention discharge process. Therefore, the storage battery control device 100 switches the process from the second charge process to the bypass prevention discharge process in response to a discharge instruction from the higher-ranking controller at the time t3. As a result, a state where all of the storage battery modules M1 to Mn are connected is maintained while the string SOC [%] decreases to D1 after the switch from the second charge process to the discharge process (in the period from the time t3 to the time t4). That is, a state where the remaining charge capacities RC of all of the storage battery modules M1 to Mn are made uniform is maintained for a certain period after the switch from the second charge process to the discharge process. Accordingly, when the process is further switched to the charge process in the period, the second charge process or the discharge process can be executed while the remaining charge capacities RC of all of the storage battery modules M1 to Mn are made uniform, and the remaining charge capacities RC of all of the storage battery modules M1 to Mn can be used up.

As described above, the storage battery control device 100 according to the embodiment executes the first charge process and the second charge process in the charge process (refer to FIG. 8). In the first charge process, the storage battery control device 100 executes the charge process while switching the storage battery modules M1 to Mn between the connection state and the bypass state using the bypass units B1 to Bn such that a difference between the plurality of remaining charge capacities RC of the plurality of storage battery modules M1 to Mn is decreased. In the second charge process after the execution of the first charge process, the storage battery control device 100 connects and charges all of the storage battery modules M1 to Mn. Therefore, unless the process is switched to the discharge process during the execution of the second charge process, the charge process can be continued until charge completion while all of the storage battery modules M1 to Mn are connected, that is, while the total voltage of the storage battery string 10 is high.

Here, when the process is switched from the charge process to the discharge process during the execution of the second charge process, the storage battery control device 100 provides the period of the bypass prevention discharge process. In the bypass prevention discharge process, the storage battery modules M1 to Mn are prevented from being switched from the connection state to the bypass state by the bypass units B1 to Bn. Therefore, when the storage battery modules M1 to Mn are switched between the charge process and the discharge process during the execution of the second charge process, the process can be switched to the second charge process or the discharge process while the remaining charge capacities RC of the storage battery modules M1 to Mn are made uniform as compared to when the period of the bypass prevention discharge process is not provided. Accordingly, even when the storage battery modules M1 to Mn are frequently switched between the charge process and the discharge process during the execution of the second charge process, the remaining charge capacities RC of all of the storage battery modules M1 to Mn can be used up.

In the storage battery control device 100 according to the embodiment, the upper limit threshold C2 of the first charge process and the lower limit threshold D1 of the bypass prevention discharge process (≤C2) that are the thresholds for the string SOC [%] are set. The storage battery control device 100 executes the second charge process in the period where the string SOC [%] is higher than or equal to the upper limit threshold C2 of the first charge process. When the process is switched from the charge process to the discharge process during the execution of the first discharge process and the second charge process, the storage battery control device 100 executes the bypass prevention discharge process in the period where the string SOC [%] is higher than or equal to the lower limit threshold D1 of the bypass prevention discharge process. As a result, when the process is switched from the charge process to the discharge process during the execution of the second charge process, the process can be prevented from being switched from the second charge process to the first discharge process, and the state where the remaining charge capacities RC of all of the storage battery modules M1 to Mn are made uniform can be prevented from being collapsed.

On the other hand, the storage battery control device 100 according to the embodiment executes the first discharge process and the second discharge process in the discharge process (refer to FIG. 7). In the first discharge process, the storage battery control device 100 executes the discharge process while switching the storage battery modules M1 to Mn between the connection state and the bypass state using the bypass units B1 to Bn such that a difference between the plurality of remaining discharge capacities RD of the plurality of storage battery modules M1 to Mn is decreased. In the second discharge process after the execution of the first discharge process, the storage battery control device 100 connects and discharges all of the storage battery modules M1 to Mn. Therefore, unless the process is switched to the charge process during the execution of the second discharge process, the discharge process can be continued until discharge completion while all of the storage battery modules M1 to Mn are connected, that is, while the total voltage of the storage battery string 10 is high.

Here, when the process is switched from the discharge process to the charge process during the execution of the second discharge process, the storage battery control device 100 provides the period of the bypass prevention charge process. In the bypass prevention charge process, the storage battery modules M1 to Mn are prevented from being switched from the connection state to the bypass state by the bypass units B1 to Bn. Therefore, when the storage battery modules M1 to Mn are switched between the discharge process and the charge process during the execution of the second discharge process, the process can be switched to the second discharge process or the charge process while the remaining discharge capacities RD of the storage battery modules M1 to Mn are made uniform as compared to when the period of the bypass prevention charge process is not provided. Accordingly, even when the storage battery modules M1 to Mn are frequently switched between the discharge process and the charge process during the execution of the second discharge process, the remaining discharge capacities RD of all of the storage battery modules M1 to Mn can be used up.

In the storage battery control device 100 according to the embodiment, the lower limit threshold D2 of the first discharge process and the upper limit threshold C1 of the bypass prevention charge process (≥D2) that are the thresholds for the string SOC [%] are set. The storage battery control device 100 executes the second discharge process in the period where the string SOC [%] is lower than or equal to the upper limit threshold C1 of the bypass prevention charge process. When the process is switched from the discharge process to the charge process during the execution of the first discharge process and the second discharge process, the storage battery control device 100 executes the bypass prevention charge process in the period where the string SOC [%] is lower than or equal to the upper limit threshold C1 of the bypass prevention charge process. As a result, when the process is switched from the discharge process to the charge process during the execution of the second discharge process, the process can be prevented from being switched from the second discharge process to the first charge process, and the state where the remaining discharge capacities RD of all of the storage battery modules M1 to Mn are made uniform can be prevented from being collapsed.

Hereinabove, the present disclosure has been described based on the embodiment. However, the present disclosure is not limited to the above-described embodiment. Within a range not departing from the scope of the present disclosure, changes may be made or combinations with well-known or commonly known techniques may be made.

For example, in the above-described embodiment, the remaining capacity of each of the storage battery modules M1 to Mn until charge completion is defined by the remaining charge capacity RC [Ah] that is the current capacity. However, the remaining capacity of each of the storage battery modules M1 to Mn until charge completion only needs to be defined by an element having a correlation with the corresponding index, for example, by a remaining charge capacity RC [Wh] that is a power capacity, and may also be defined by SOC or open circuit voltage (OCV). Likewise, the remaining capacity of each of the storage battery modules M1 to Mn until discharge completion is not limited to the remaining discharge capacity RD [Ah] that is the current capacity. However, the remaining capacity of each of the storage battery modules M1 to Mn until discharge completion only needs to be defined by an element having a correlation with the corresponding index, for example, by a remaining discharge capacity RD [Wh] that is a power capacity, and may also be defined by SOC or open circuit voltage (OCV).

In the above-described embodiment, the remaining charge capacities RC of the plurality of storage battery modules M1 to Mn are decreased until the minimum value at the start of the first charge process. However, the remaining charge capacities RC of the plurality of storage battery modules M1 to Mn may be decreased until a value that is lower than the minimum value at the start of the first charge process. Likewise, in the first discharge process, the remaining discharge capacities RD of the plurality of storage battery modules M1 to Mn do not need to be decreased until the minimum value at the start of the first discharge process and may be decreased until a value that is lower than the minimum value at the start of the first discharge process.

From the viewpoint of finally using up the remaining charge capacities RC of all of the storage battery modules M1 to Mn and the viewpoint of making the timings of charge completion of all of the storage battery modules M1 to Mn uniform, it is preferable that the remaining charge capacities RC of the plurality of storage battery modules M1 to Mn are made uniform in the first charge process. However, the remaining charge capacities RC of the plurality of storage battery modules M1 to Mn do not need to be made uniform in the first charge process, and a difference between the remaining charge capacities RC of the plurality of storage battery modules M1 to Mn only needs to be decreased to be less than that at the start of charge in the first charge process. Likewise, the remaining discharge capacities RD of the plurality of storage battery modules M1 to Mn do not need to be made uniform in the first discharge process, and a difference between the remaining discharge capacities RD of the plurality of storage battery modules M1 to Mn only needs to be decreased to be less than that at the start of discharge in the first discharge process.

Both of the bypass prevention charge process and the bypass prevention discharge process do not need to be executed. Any one of the bypass prevention charge process or the bypass prevention discharge process may be executed. Both of the first charge process and the second charge process do not need to be executed in the charge process, and both of the first discharge process and the second discharge process do not need to be executed in the discharge process. Any one of the first charge process and the second charge process may be executed in the charge process, and any one of the first discharge process and the second discharge process may be executed in the discharge process.

In the above-described embodiment, the state of charge of the storage battery string 10 is defined by the string SOC [%]. However, the state of charge of the storage battery string 10 only needs to be defined by an element having a correlation with the corresponding index and may be defined by the total voltage of the storage battery string 10.

According to a first aspect of the present disclosure, there is provided a storage battery control device (100) that controls a storage battery string (10) including a plurality of storage batteries (M1 to Mn) connected in series and a bypass circuit (20) configured to switch the plurality of storage batteries (M1 to Mn) between a bypass state and a connection state, in which: in a process of charging or discharging the plurality of storage batteries (M1 to Mn), a first process and a second process are executed; in the first process, while causing the bypass circuit (20) to switch the plurality of storage batteries (M1 to Mn) between the bypass state and the connection state, the process is executed to decrease a difference between remaining capacities of the plurality of storage batteries (M1 to Mn) until completion of the process; in the second process, the process is executed while causing the bypass circuit (20) to maintain the plurality of storage batteries (M1 to Mn) in the connection state after the execution of the first process; and during the execution of the second process, when the process is switched from charge to discharge or from discharge to charge, a period where a bypass prevention process of preventing the bypass circuit (20) from switching the plurality of storage batteries (M1 to Mn) from the connection state to the bypass state is executed is provided.

According to a second aspect of the present disclosure, the process may be a process of charging the plurality of storage batteries (M1 to Mn), a first threshold and a second threshold that is the first threshold or lower may be set for a state of charge of the storage battery string (10), the second process may be executed in a period where the state of charge of the storage battery string (10) is the first threshold or higher, and during the execution of the first process and the second process, when the process is switched from charge to discharge, the bypass prevention process may be executed in a period where the state of charge of the storage battery string (10) is the second threshold or higher.

According to a third aspect of the present disclosure, the process may be a process of discharging the plurality of storage batteries (M1 to Mn), a third threshold and a fourth threshold that is the third threshold or higher may be set for a state of charge of the storage battery string (10), the second process may be executed in a period where the state of charge of the storage battery string (10) is the third threshold or lower, and during the execution of the first process and the second process, when the process is switched from discharge to charge, the bypass prevention process may be executed in a period where the state of charge of the storage battery string (10) is the fourth threshold or lower.

According to a fourth aspect of the present disclosure, there is provided a power storage system (1) including: a storage battery string (10) including a plurality of storage batteries (M1 to Mn) connected in series and a bypass circuit (20) configured to switch the plurality of storage batteries (M1 to Mn) between a bypass state and a connection state; and a storage battery control device (100) configured to control the storage battery string (10), in which: the storage battery control device (100) executes a first process and a second process in a process of charging or discharging the plurality of storage batteries (M1 to Mn); in the first process, while causing the bypass circuit (20) to switch the plurality of storage batteries (M1 to Mn) between the bypass state and the connection state, the process is executed to decrease a difference between remaining capacities of the plurality of storage batteries (M1 to Mn) until completion of the process; in the second process, the process is executed while causing the bypass circuit (20) to maintain the plurality of storage batteries (M1 to Mn) in the connection state after the execution of the first process; and during the execution of the second process, when the process is switched from charge to discharge or from discharge to charge, a period where a bypass prevention process of preventing the bypass circuit (20) from switching the plurality of storage batteries (M1 to Mn) from the connection state to the bypass state is executed is provided.

According to a fourth aspect of the present disclosure, there is provided a storage battery control method that is executed by a storage battery control device (100) that controls a storage battery string (10) including a plurality of storage batteries (M1 to Mn) connected in series and a bypass circuit (20) configured to switch the plurality of storage batteries (M1 to Mn) between a bypass state and a connection state, in which: in a process of charging or discharging the plurality of storage batteries (M1 to Mn), a first procedure and a second procedure are executed; in the first procedure, while causing the bypass circuit (20) to switch the plurality of storage batteries (M1 to Mn) between the bypass state and the connection state, the process is executed to decrease a difference between remaining capacities of the plurality of storage batteries (M1 to Mn) until completion of the process; in the second procedure, the process is executed while causing the bypass circuit (20) to maintain the plurality of storage batteries (M1 to Mn) in the connection state after the execution of the first procedure; and during the execution of the second procedure, when the process is switched from charge to discharge or from discharge to charge, a period where a bypass prevention procedure of preventing the bypass circuit (20) from switching the plurality of storage batteries (M1 to Mn) from the connection state to the bypass state is executed is provided.

According to the present disclosure, in a storage battery string where a plurality of storage batteries are connected in series and each of the storage batteries is switched between a connection state and a bypass state, even when the storage batteries are frequently switched between charge and discharge, a usable capacity of the plurality of storage batteries can be increased.

What is claimed is:

1. A storage battery control device that controls a storage battery string including a plurality of storage batteries connected in series and a bypass circuit configured to switch the plurality of storage batteries between a bypass state and a connection state, wherein:
in a process of charging or discharging the plurality of storage batteries, a first process and a second process are executed;
in the first process, while causing the bypass circuit to switch the plurality of storage batteries between the bypass state and the connection state, the process is executed to decrease a difference between remaining capacities of the plurality of storage batteries until completion of the process;
in the second process, the process is executed while causing the bypass circuit to maintain the plurality of storage batteries in the connection state after the execution of the first process; and
during the execution of the second process, when the process is switched from charge to discharge or from discharge to charge, a period where a bypass prevention process of preventing the bypass circuit from switching the plurality of storage batteries from the connection state to the bypass state is executed is provided.

2. The storage battery control device according to claim 1, wherein:
the process is a process of charging the plurality of storage batteries;
a first threshold and a second threshold that is the first threshold or lower are set for a state of charge of the storage battery string;
the second process is executed in a period where the state of charge of the storage battery string is the first threshold or higher; and
during the execution of the first process and the second process, when the process is switched from charge to discharge, the bypass prevention process is executed in a period where the state of charge of the storage battery string is the second threshold or higher.

3. The storage battery control device according to claim 1, wherein:
the process is a process of discharging the plurality of storage batteries;
a third threshold and a fourth threshold that is the third threshold or higher are set for a state of charge of the storage battery string;
the second process is executed in a period where the state of charge of the storage battery string is the third threshold or lower; and
during the execution of the first process and the second process, when the process is switched from discharge to charge, the bypass prevention process is executed in a period where the state of charge of the storage battery string is the fourth threshold or lower.

4. A power storage system comprising:
a storage battery string including a plurality of storage batteries connected in series and a bypass circuit configured to switch the plurality of storage batteries between a bypass state and a connection state; and
a storage battery control device configured to control the storage battery string, wherein:
the storage battery control device executes a first process and a second process in a process of charging or discharging the plurality of storage batteries;
in the first process, while causing the bypass circuit to switch the plurality of storage batteries between the bypass state and the connection state, the process is executed to decrease a difference between remaining capacities of the plurality of storage batteries until completion of the process;
in the second process, the process is executed while causing the bypass circuit to maintain the plurality of storage batteries in the connection state after the execution of the first process; and
during the execution of the second process, when the process is switched from charge to discharge or from discharge to charge, a period where a bypass prevention process of preventing the bypass circuit from switching the plurality of storage batteries from the connection state to the bypass state is executed is provided.

5. A storage battery control method that is executed by a storage battery control device that controls a storage battery string including a plurality of storage batteries connected in series and a bypass circuit configured to switch the plurality of storage batteries between a bypass state and a connection state, wherein:
in a process of charging or discharging the plurality of storage batteries, a first procedure and a second procedure are executed;
in the first procedure, while causing the bypass circuit to switch the plurality of storage batteries between the bypass state and the connection state, the process is executed to decrease a difference between remaining capacities of the plurality of storage batteries until completion of the process;
in the second procedure, the process is executed while causing the bypass circuit to maintain the plurality of storage batteries in the connection state after the execution of the first procedure; and
during the execution of the second procedure, when the process is switched from charge to discharge or from discharge to charge, a period where a bypass prevention procedure of preventing the bypass circuit from switching the plurality of storage batteries from the connection state to the bypass state is executed is provided.
